(19) United States
(12) Patent Application Publication
(10) Pub. No.: US 2005/0114828 A1
(43) Pub. Date: May 26, 2005

(54) Method and structure for efficient assessment and planning of software project efforts involving existing software

(75) Inventors: Walter C. Dietrich JR., Yorktown Heights, NY (US); Bonnie K. Ray, South Nyack, NY (US); Wendy D. Neuberger, Vestal, NY (US); Michael W. Crow, Plant City, FL (US); Patrick Haren, Madison, CT (US); Jonathan B. Novak, Atlanta, GA (US); Howard M. Hess, Winnetka, IL (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/721,242

(22) Filed: Nov. 26, 2003

(51) Int. Cl. G06F 9/44

(52) U.S. Cl. 717/101

(57) ABSTRACT

A method (and structure) of estimating a cost related to at least one of computer software development, maintenance, and information technology services. A section of computer code is read in accordance with a sampling technique. The cost for a larger subset of the computer code is calculated from the sampling. At least one of the reading, sampling, and calculating is executed on a computer.

### BACKGROUND OF THE INVENTION

1. Field of the Invention

The present invention generally relates to efficient estimation of cost or resources required for software projects such as porting existing computer code to a different platform or maintenance of existing computer code. More specifically, a sampling of code in the software system, obtained either by sampling a listing of code lines in one or more programs or by sampling modules or programs from a system of programs, is used to calculate resources and/or cost required for the project for a larger subset of the code.

2. Description of the Related Art

There is a need for efficient estimation of effort for porting applications from one platform to another, maintenance of existing software, application portfolio management of software, and legacy transformation of software, for the purposes of cost estimation or resource planning. Although project cost estimation methods are widely available for software development projects, the previously mentioned efforts are different in that the software already exists and can be studied to predict potential problems.

For purpose of the present invention, “porting applications from one platform to another” means making zero or more changes in the applications so that they will run on another platform (e.g., the “target platform”) and give the same (or nearly the same) results that they gave on the previous platform (e.g., the “source platform”). A platform consists of a combination of hardware, operating system software, and infrastructure software (such as middleware and/or database software).

Porting is frequently carried out using a process that involves analyzing the software, changing it, and testing it on the target platform and possibly even on the source platform. The following are examples of software porting projects:
Changing software that runs on Microsoft Windows NT® on Intel Pentium®-based hardware so that it runs on Linux on the same Pentium® hardware. This is a port to change the operating system.
Changing software that runs on the Sun Microsystems Solaris operating system and a SPARC-based system so that runs on the IBM AIX operating system and a POWER-based system. This is a port to change both the operating system and the hardware.
Changing software that runs on an Oracle® database system to run on an IBM database system (such as DB2®), but continues to run on the same operating system and hardware. This is a port to change database systems.

Porting may be simple or it may be complex, depending on the application that is being ported and the source and target platforms. A comprehensive investigation requires scanning the entire set of code to look for potential problems. This process can be very expensive and time consuming, especially for large amounts of code or when using manual methods of scanning.

Thus, current methods for estimating porting effort are based on high level metrics, such as number of source lines of code (SLOC), type of source and target platform, programming languages involved in the port, etc. Until the present invention, no method has existed to efficiently estimate the effort to port source code from one platform to another.

Application Portfolio Management (APM) treats an enterprise's software as a portfolio of assets that should be managed to ensure that short-term and long-term goals are met. In APM, enterprises transform their application portfolios to dynamically adapt to the needs of customers, employees, and partners. APM includes identifying and publishing information encoded in applications; integrating application data functionality within and beyond enterprises, and optimizing operations to dynamically respond to the changing needs of customers, employees, and partners. For a more complete description Application Portfolio Management, see http://www-1.ibm.com/services/ams/apm.html.

Legacy Transformation (LT) helps enterprises unlock the value of their existing (legacy) software. LT includes conversions to support enterprise-wide, Web-enabled sharing of data to facilitate better linkage of IT and enterprise goals; incremental transformations of legacy business logic and functionality for improved responsiveness to enterprise change; and improvements in the efficiency of maintenance and operation of legacy applications. For a more complete description of services related to Legacy Transformation, see http://www-1.ibm.com/services/ams/legtran.html.

In other fields that also require an efficient estimate of potential problems that will be encountered in large projects, such as auditing of accounting records, methods based on statistical sampling are sometimes used. See, for example, Statistical Sampling and Risk Analysis in Auditing, (1998) by P. Jones and published by Gower. However, no such methods are currently in use for estimating potential problems in software and for tying these estimates to estimates of cost, estimates of resources, and allowing for management of the risk that the estimates will be wrong because they are based on sampling.

The Project Management Institute, a project management professional association, has created a Project Management Body of Knowledge (PMBOK), as described, for example in “A Guide to the Project Management Body of Knowledge (PMBOK)-2000 Edition”, Project Management Institute, 2000. The PMBOK covers resource planning and cost estimation in Chapter 7 (Project Cost Management) and risk management in Chapter 11 (Project Risk Management). The methods proposed there are not based on a sampling of source lines of code.

Thus, a need exists in software projects, such as porting from one platform to another, of an efficient method to estimate the effort, for example, to port source code across platforms.

### SUMMARY OF THE INVENTION

In view of the foregoing exemplary problems, drawbacks, and disadvantages of the conventional systems, it is an exemplary feature of the present invention to provide a method, structure, and system in which computer code is sampled in accordance with a sampling technique in order to allow a calculation for an estimate of at least one of a cost or an amount of resources necessary to perform an effort on a larger subset of the computer code, as based on the sampling. The effort to be performed might be a porting of the computer code from a first platform to a second platform, a maintenance or updating of the computer code, an application portfolio management of the computer code, a legacy transformation of the computer code, or any other suitable operation which may be envisioned by one of ordinary skill in the art after reading the present specification, etc.

In a first exemplary aspect of the present invention, described herein is a method, structure, and system of estimating a cost related to at least one of computer software development, computer software maintenance, and information technology services. A sample of computer code is read in accordance with a sampling technique. The cost for a larger subset of the computer code is calculated from the sampling. At least one of the reading, the sampling, and the calculating is executed on a computer.

In a second exemplary aspect of the present invention, described herein is a method, structure, and system of estimating necessary amounts of resources for an effort related to at least one of computer software development, computer software maintenance, and information technology services. A sample of computer code is read in accordance with a sampling technique. Resources for a larger subset of the computer code are calculated from the sampling. At least one of the reading, the sampling, and the calculating is executed on a computer.

In a third exemplary aspect of the present invention, described herein is a business method including at least one of: estimating a cost for an effort related to at least one of computer software development and IT services by sampling the computer code in accordance with a sampling technique, calculating the cost for a larger subset of the computer code from the sampling, and calculating at least one of a risk probability and an estimation precision for the cost; providing a result of the calculating to a party; and receiving the result of the calculating.

In a fourth exemplary aspect of the present invention, described herein is a business method including at least one of: estimating a necessary amount of resources for an effort related to at least one of computer software development and IT services by sampling computer code in accordance with a sampling technique, calculating the necessary amount of resources for a larger subset of the computer code from the sampled computer code, and calculating at least one of a risk probability and an estimation precision for the estimate of resources; providing a result of the calculating to a party; and receiving the result of the calculating. At least one of the reading, sampling, and calculating is executed on a computer.

In a fifth exemplary aspect of the present invention, also described herein is a signal-bearing medium tangibly embodying a program of machine-readable instructions executable by a digital processing apparatus to perform at least one of the above-described methods.

### BRIEF DESCRIPTION OF THE DRAWINGS

The foregoing and other exemplary purposes, features, aspects and advantages will be better understood from the following detailed description of an exemplary embodiment of the invention with reference to the drawings, in which:

FIG. 1 shows an overview 100 of how the present invention uses a sampling of lines of code to estimate a cost;

FIG. 2 shows a flowchart of an exemplary embodiment 200 in which a user provides complexity category inputs for the sampled lines of code for the purpose of estimating cost and, optionally, risk parameters, which are defined below;

FIG. 3 shows how the present invention can be used as various embodiments 300 as a business process and/or automated tool that estimates project resources, cost, potential cost overruns, potential resource shortfalls, and/or probability of overruns or shortfalls;

FIG. 4 illustrates an exemplary block diagram 400 of an apparatus designed to execute the present invention;

FIGS. 5 and 6 show a flowchart of an exemplary embodiment 500 and 600 in which a user provides complexity category inputs for the sampled lines of code for the purpose of resource estimation, optionally calculating risk parameters (defined below), optionally calculating a resource plan, optionally calculating a work breakdown structure, and optionally calculating a risk management plan;

FIG. 7 illustrates an exemplary hardware/information handling system 700 for incorporating the present invention therein; and

FIG. 8 illustrates a signal bearing medium 800 (e.g., storage medium) for storing steps of a program of a method according to the present invention.

### DETAILED DESCRIPTION OF EXEMPLARY EMBODIMENTS OF THE INVENTION

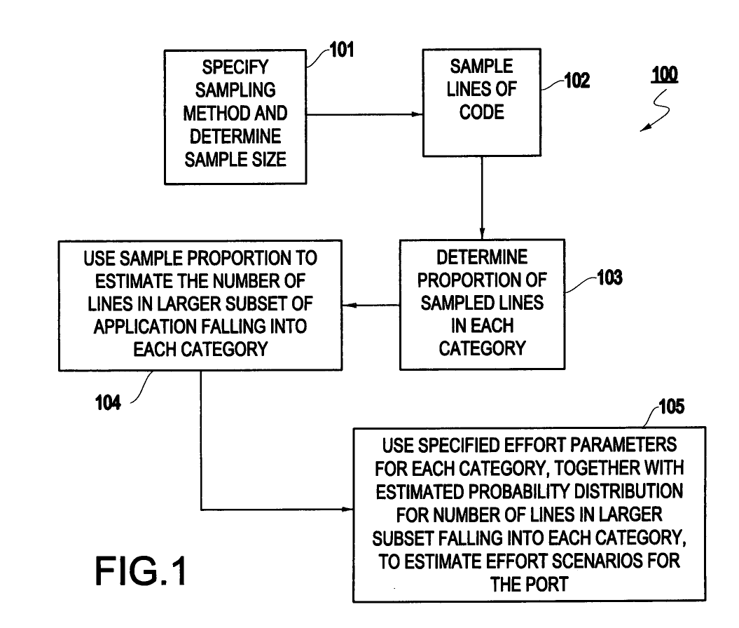

Referring now to the drawings, and more particularly to FIGS. 1-8, there are shown various exemplary embodiments of the method and structures according to the present invention.

Described herein is a method for more efficient code assessment, based on analysis of a sampled subset of the code to be ported. Sampling techniques, of which statistically-based sampling is an exemplary method, are used to obtain estimates of the number of potential problems (i.e., anomalies) in the port. The number of anomalies is used to estimate the cost and/or the resources required to perform an activity (such as porting) that uses the code.

When using sampling, there is a risk that the resulting estimates will be incorrect because a subset was examined instead of the entire set of interest. There are project management techniques that can be used to manage this risk (and many other kinds of risks). These techniques are most effective when the risks can be quantified. Described herein are exemplary methods for calculating the probabilities that the estimates will be too low and for calculating the differences between the estimated amounts and the worst-case (or nearly worst-case) amounts.

In the remainder of the present specification, and in the figures, risks are defined as events that occur when the estimates have errors because of sampling variability; risk probabilities are defined as probabilities that this risk occurs; estimate precision (or simply precision) is defined as the difference, caused by sampling variability, between the estimated amount and the correct amount, and risk parameters are defined as risk probability and estimate precision.

The methods described herein can also be applied to other areas of software project planning, in particular, software maintenance effort estimation. The procedures and implementation proposed herein for the analysis of software are completely new, including the aspect of automated generation of source code samples. The sample results can be used for cost estimation and/or resource planning, incorporating allowance for risks (as defined above), and can be the basis of a business process.

FIG. 1 shows an overview 100 of an exemplary implementation of the present invention. In step 101, a sampling method and, perhaps, the desired accuracy, of the estimated number of potential anomalies in an application whose porting, maintenance, updating, APM, or LT effort is to be estimated are specified.

In step 102, an automated computer code will then sample lines of code in accordance with the user's input in step 101 for the sampling technique specified.

In step 103, each sampled line is classified into one of several pre-established categories.

In step 104, the number of lines in the application that are determined to fall within each category can now be estimated, based on the proportion of sampled lines in each category to the overall number of lines of code in the application.

In step 105, the total estimated effort can now be calculated, based on a predetermined effort function for each category. Although generic effort is the parameter identified in this initial discussion, it is noted that parameters of the effort, such as resource requirements or cost, could also be objective for the estimate for the sampling of the code.

It is also noted that the computer code for which the effort estimation is being made may include more than one computer program. Indeed, a typical porting or maintenance project would include many computer programs interconnected in various call or data-sharing techniques.

This method 100 efficiently assesses the effort involved in porting a software application to a different platform by basing assessment on characterization of, for example, a random sample of the application's lines of code. The exemplary technique 100 shown in FIG. 1, includes the following key aspects:
The ability to specify the desired sample design discussed above for step 101. For example, simple random sampling, cluster sampling, or stratified sampling with specified stratification parameters can exemplarily be used for the sampling technique, as will be discussed shortly.
The ability to specify a desired degree of granularity in the assessment of categories in step 103. For example, lines can be categorized into such categories as: Potentially Hard to Port, Potentially Moderately Difficult to Port, Potentially Easy to Port.
The ability to specify a desired accuracy and a level of confidence in the estimated results.
Use of an automated method for drawing the samples in step 102.
Use of an automated method for placing sampled lines into categories in step 103.

Probabilistic aspects underlying the sampling allow a range of effort estimates to be computed with associated probabilities of occurrence. The methods discussed herein also apply to software maintenance, APM, and LT effort estimation.

As mentioned above and to be discussed below, different methods of statistical sampling can be used for sampling the code, dependent on the particular application and the tools available for analyzing the samples.

Example Program for Sampling-Based Assessment

Before proceeding with details of estimation and risk calculations, it is noted that the present invention can also be implemented as a business process, in which at least some of the steps are done manually or with the assistance of general purpose tools such as spreadsheets and statistical calculators or fully implemented with software.

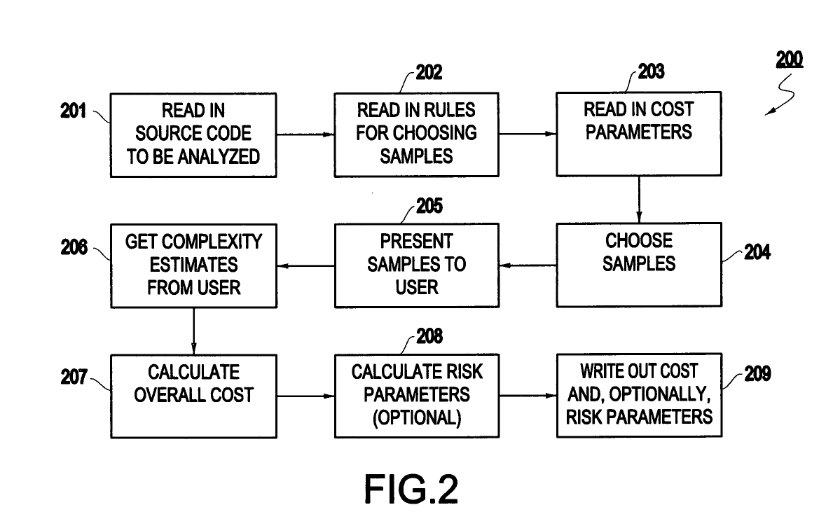

Accordingly, FIG. 2 shows an exemplary process 200 of one version of the present invention, in which either a user can be involved in some steps of the process, or in which another program can perform tasks to automate the process of extracting a sample and estimating overall cost, along with associated risk parameters.

First, in step 201 of FIG. 2, the program inputs the source code to be analyzed. In step 202, the program receives the rules for choosing the samples from the listing of source code that was input in step 201. The sampling rules could be simple rules or complex rules.

A simple rule might be one that states which type of sample is to be taken (e.g., simple random, cluster, or stratified) and the desired precision of the estimates. A more complex rule might state properties that are important when taking a stratified sample, such as the names of troublesome “include” files.

In the next step 203, the program reads in cost parameters. These parameters include, for example, generic information about the cost of porting. Generic information includes the names of the categories of anomalies and the estimated cost to port one instance of each category of anomaly. An anomaly occurs when a program must be changed during a port.

For example, sample categories might be “easy anomaly” in which a simple change eliminates the anomaly, and “complex anomaly”, in which a complex change must be made to eliminate the anomaly. However, it should be apparent that the invention allows a large number of categories and a wide variation in the costs of the categories.

For each programming language/operating system/platform that is in the source code to be analyzed, category names and costs are read in. The category names are represented by N1, N2, . . . Nn, and the costs are represented by C1, C2, . . . Cn.

In step 204, the program chooses the samples using the sampling rules that are read in as part of step 202. If the user is to interact with the program to provide the category designations, then in step 205, the samples are presented to the user. In step 206, the user then enters complexity estimates I1, I2, . . . , In, where Ix is the number of samples that are in category Nx, where 1≦x≦n.

This user input can be done in a variety of ways. For example, the program could have a graphical user interface (GUI) that allows the user to click on a sample and then click on the sample's category or “no category” (which signals that the sample does not contain any anomalies of which the user is aware).

It should also be apparent to one of ordinary skill in the art that the complexity estimates could also be automated. For example, a number of commercially available programs that parse lines of code and thereinafter perform some type of function on the parsed code could be used or modified for the categorization function. Examples of such programs include an IBM tool called PortingManager® that is a free download on the AlphaWorks web site (http://www.alphaworks.ibm.com/) or the tools and services for porting code from 32-bit processors to 64-bit processors (64Express®) and from/to several different source/target platforms (32Direct®) commercially available from a company named MigraTEC.

Using the sample size, the total size of the source code, Cx, and the complexity estimate Ix, where 1≦x≦n, the program in step 207 then calculates the estimated cost of porting the source code. The cost is calculated by taking the sum of the products Cx times Ix, multiplying this sum by the total size of the source code, and dividing by the sample size.

If desired, in step 208, the program uses the above results to calculate the approximate probability distribution of the estimated totals in each category from statistical theory, dependent on the type of sample taken. This probability distribution can be used, for example, to compute the probability distributions of cost and/or resource estimates, from which cost and resource estimate contingencies can be computed.

Finally, in step 209, the program writes out the estimated cost and, optionally, the risk estimates, for example on either the GUI or, possibly, into a data file for printing out the result or for use in another program or even possibly to some other communication medium for use in another program.

The output could be used by other types of programs, such as project planning programs that would then take this estimated cost, and/or one or more risk estimates to further incorporate them into a larger planning problem. The output could be also be incorporated into a program that helps prepare bids for projects.

Methods Based on Simple Random Sampling

Simple random sampling is applicable when analyzing individual lines of code (e.g., within the context of their files or modules), and is relatively easy. However, when tools or processes require that entire files or modules be analyzed in order to obtain results that are meaningful for individual lines (or statements), cluster-based sampling (discussed below) is more appropriate.

As an example, a human can scan individual lines relatively easily. A tool that parses the files to analyze code must parse all of the lines leading up to the line in question. In this case, it may be better to have the tool analyze the whole file.

The following steps provide a method for implementation of simple random sampling.

1. Create one file including all lines of code (LOC) from all program modules, excluding blank and comment lines.

2. Determine the sample size, n, which is a function of the desired accuracy, the level of confidence in results, and the number of categories. Methods for determining n are well known in the art. For example, one possible technique can be found in, e.g., Sampling Techniques, 3rd Edition (1976) by W. G. Cochran and published by Wiley.

3. Generate n values (without replacement) from discrete uniform distribution, taking values 1, . . . , Total LOC. These values determine the sampled lines.

4. Using manual methods or existing tools, assign each sampled line to a category and estimate the proportion in category j as pj=(# sampled lines in category j)/n.

5. Use the sample proportions to extrapolate the number of Total LOC in each category. Using appropriate formulas, form interval estimates of the number in each category with some specified level of confidence. Appropriate formulas can be found in, for example, Sampling Techniques, 3rd Edition (1976) by W. G. Cochran and published by Wiley.

Methods Based on Cluster Sampling

In cluster-based sampling, samples include predefined groups of individual sampling units. For example, in survey sampling, all houses on a city block might comprise a cluster, with individual houses considered a unit.

In porting projects, typical applications contain a number of modules that are combined to produce a working program. Frequently, there is a one-to-one or one-to-many relationship between modules of a program and source code files for the application. In analyzing a single application, a subset of all of the modules or files can be analyzed in order to estimate the overall cost of a port.

When analyzing large groups of applications, two approaches for cluster sampling can be used. The first approach is the same as the approach for a single application, i.e., a subset of the union of all of the files/modules in the entire group of applications is selected for analysis without necessarily selecting all of the files related to a certain application. A second approach is to analyze a subset of all of the applications in order to estimate the overall cost of a port.

This second approach may be preferable when either (1) the tools available work best when analyzing entire applications or (2) the number of anomalies will be estimated by actually porting the sample applications. This approach also works well in phased porting projects, in which groups of applications are ported in different phases because the actual costs of porting the first group can be used to estimate the costs of porting other groups (assuming the first group is a representative sample).

An exemplary sequence of the steps that might be followed in cluster sampling are as follows:
1. Determine LOC in each of M program modules, optionally excluding blank and comment lines.

2. Take a random sample of n program modules (simple random sample or weighted random sample, where weight for module m=(LOC for module m)/(Total LOC). The number n is determined as a function of the desired accuracy, the level of confidence in results, and the number of categories.

3. Assign each line in sampled modules to a category and obtain an interval estimate of total number of lines of code in the larger subset of code that fall into category j using appropriate formulas to guarantee a specified level of confidence in results.

Methods Based on Stratified Sampling

If certain properties of a program can be determined prior to sampling (without assessment of the entire application), these factors can be used to stratify the code into subpopulations which can then be sampled independently. In this way, programs that contain properties that are known to cause problems during a port are guaranteed to be included in the sample.

Properties that are known to cause problems and, thus, could be considered for stratified sampling include the use of ‘include’ files that define hard-to-port APIs (Application Program Interfaces), multiple inheritance in C++, templates in C++, inheritance of classes that contain hard-to-port APIs, depth on a static call graph, depth in an inheritance tree, and so forth. Stratified sampling can be used to increase the probability of finding anomalies during assessment.

An exemplary sequence of the steps that might be followed in stratified sampling are as follows:
1. Specify stratification properties.
2. For each strata, create one file including all lines of code (LOC) from all program modules in the strata, excluding blank and comment lines.
3. For each strata i, determine the sample size, nᵢ, which is a function of the desired accuracy, the level of confidence in results, the number of categories, and the number of strata.
4. For each strata i, generate nᵢ values (without replacement) from discrete uniform distribution, taking values 1, . . . , Total LOCᵢ. These values determine the sampled lines for strata i.
5. Using manual methods or existing tools, assign each sampled line to a category.
6. Using appropriate formulas for combining results from each strata, estimate the number of anomalies in each category with some specified level of confidence.

Use of Sampling Results for Cost Estimation

Once interval estimates for the number of items falling into each category have been obtained, cost-based methods can be used to assign a project cost to the port. For example, a project may be planned using “average-case” estimates for cost, where the average-case cost is a function of the sampling-based point estimates of the number of anomalies in each category.

This invention for sampling existing lines of code allows projects to be planned using the average-case method and also supports the allocation of a contingency for the difference between the worst-case cost and the average-case cost, where the worst-case cost estimate may be calculated, for example, using probabilistic estimates that the number of anomalies exceeds a specified bound. In many cases, the allocation of a contingency based on this difference would be too expensive.

This invention also supports the allocation of a contingency based on the “expected monetary value” of the risk due to sampling, which is the result of multiplying the difference between two specified upper percentiles of the estimated cost distribution by the risk probability. For example, a contingency could be calculated by multiplying the difference between the 99th and 95th percentiles of the cost distribution by 4%.

### EXEMPLARY ALTERNATIVE EMBODIMENTS

Many alternate implementations are possible. The following discussion shows some exemplary variations that can be considered, depending on the tools available and the scope of the sets of source code to be analyzed.

Exemplary Alternate Implementation #1

In a first exemplary alternate embodiment, the program first reads in information about the files or modules in the source code to be analyzed. This step is useful when reading in the source code is inefficient (because of the size), impossible (because it is not all available because of contractual or other requirements), or undesirable for some other reason.

Then, using the information about the files or modules to be examined and the information read in during steps 202 and 203 in FIG. 2, files or modules are chosen that will be sampled in their entirety.

Alternately, files or modules are chosen and then lines from those files or modules are chosen in accordance with the sampling rules. A key advantage is that this alternative does not require all of the files to be parsed.

If a cluster sample is chosen, only some of the files would have to be read. If a stratified sample is to be taken, a scheme could be designed in which all of the files were scanned for characteristics that are easy to detect (such as C++ file includes), but only a subset of the files were selected for more expensive processing (such as parsing).

Exemplary Alternate Implementation 2:

If a tool is used to analyze a sample and assign it to the categories N1, . . . NN, the program passes the samples to the tool and gets back calculations I1, . . . IN, based on the tool's results.

The Present Invention Implemented as a Business Method

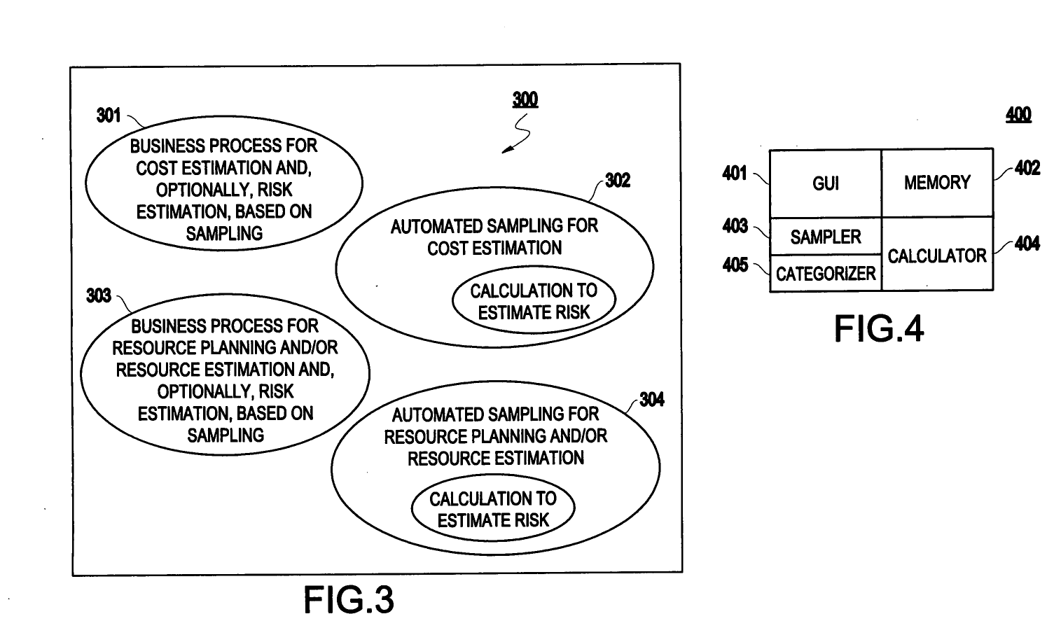

Returning again to FIG. 3, a number of other aspects of the present invention are now discussed. As shown in 301 and discussed above, the present invention provides the sampling techniques that can be the basis of a business process in which cost of a software effort such as porting or maintenance is estimated. The present invention also teaches techniques in which risk due to sampling can be taken into account. It should be noted that this business process could, in theory, be implemented as a totally manual process, but would more typically involve a computer for at least the step in which the computer code lines or various computer programs are presented for user viewing in order that the user can carry out the steps of sampling and executing the cost functions.

As shown in the block diagram in FIG. 4, in this basic computerized version of business process 301, the computer tool 400 would include at least a GUI 401 to allow the user to select computer code from memory 402 for sampling and to view on GUI 401 the selected computer code to be sampled.

In one possible basic version of the present invention, the user would then manually execute the sampling via the GUI and could manually then categorize the sampled selections of code, again via the GUI. In this version, the GUI might be programmed to send the sampled selections of code and the user's categorizations back into a file in memory 402 to be retrieved during the calculation stages for cost and, perhaps, variability and risk. Alternatively, the sampled selections and categorizations might be sent into an external applications program that provides the for cost calculations in conjunction with other project planning functions.

As an alternative, the software tool 400 might further include a software module that automatically executes sampling of the computer code. In this version, the computer tool 400 would include a sampler module 403. If the cost and other calculations such as risk due to sampling are to be automatically calculated, then computer tool 400 would include software modules 404 for calculation of these various results. If, further, the categorization function is performed automatically, then software tool 400 would also include a categorizer module 405.

Item 302 in FIG. 3 shows the higher level view of this version of the present invention in which an apparatus automatically executes the business process described by item 301.

Item 303 of FIG. 3 shows another business process in accordance with the present invention. In 303, resource planning is performed for a software effort such as 5 and 6 show an exemplary process 500, 600 of one version of the present invention for at least one of resource estimation, resource planning, work breakdown structure calculation, and risk management planning, with optional sampling risk calculation.

Whereas the present invention's application to cost estimation applies a cost to each category of anomaly, the invention's application to resource planning applies a set of resources to each category of anomaly. This set of resources contains a resource type (such as a person with certain skill levels, a certain piece of equipment, or a material) and an amount of the resource (such as an amount of time for a person or piece of equipment, or a quantity of material). (The cost parameters are read in step 203; the resource set parameters are read in step 503.)

The formulas that are used for cost estimation and sampling risk parameter calculation can be applied to each type of resource in order to do resource planning. The result is a set of resources types (with quantities for each) that will be needed for a larger subset of the project, optionally, the variance for each type (optional), and, optionally, the probability that the actual amount of resource needed will fall outside of the expected amount.

The optional risk calculations are performed in step 508. Furthermore, if a template project plan or work breakdown structure that allows for variable amounts of each resource type has been defined, this invention allows the calculated amounts to be inserted into the template project plan (part of step 604) or work breakdown structure (part of step 607) in order to create a project plan or work breakdown structure for the software that was sampled. If a template risk management plan has been created, the quantities associated with the sampling risks can be inserted into the risk management plan template in order to create a risk management plan for the software that was sampled (part of step 610).

The above discussion for business process 301, relative to manual versus software implementation for the various steps, applies equally to this aspect of the invention in which at least one of resource estimation, resource planning, risk management planning is directly calculated via the sampling concept of the present invention.

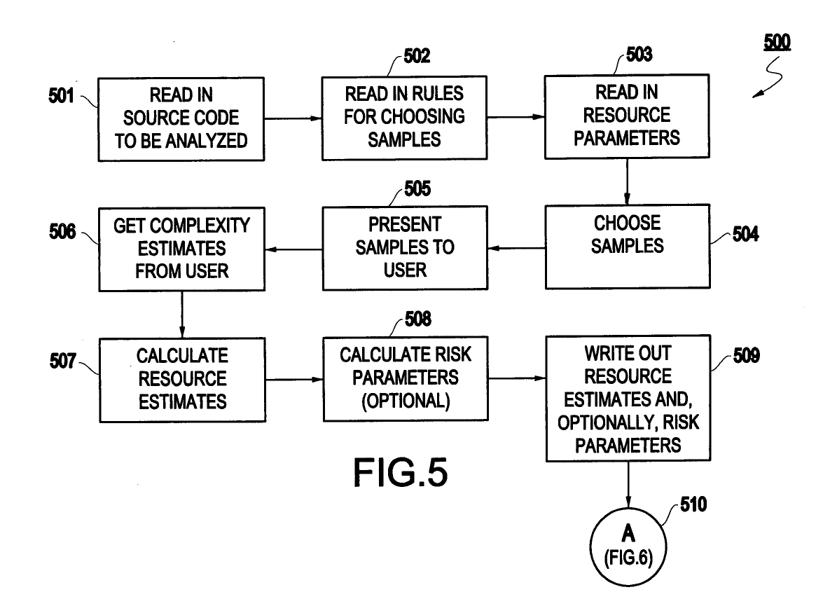

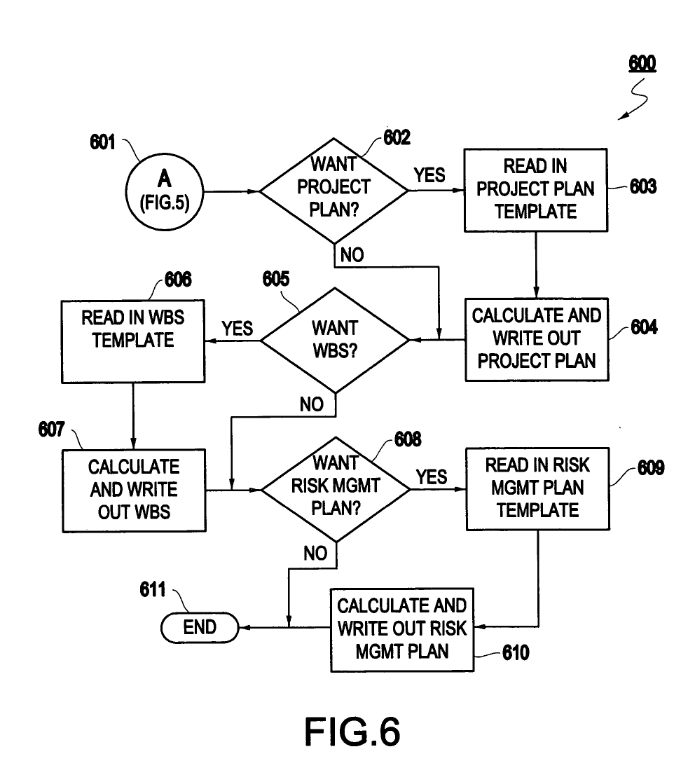

Another alternate embodiment of the invention includes all of the steps in FIG. 5 and none of the steps in FIG. 6. Other alternative embodiments include all of FIG. 5 but only 602, 603, and 604; only 605, 606, and 607; only 608, 609, and 610; or FIG. 5 and logical combinations of the three groups of three steps, such as FIG. 5 and steps 602 to 607.

Similar to the apparatus 302 for the automated sampling for cost estimation, a corresponding apparatus 304 provides automated sampling for at least one of resource estimation, resource planning, and, optionally, risk management. At a lower level, this apparatus 304 would have corresponding structure 400 to that shown in FIG. 4 and would correspondingly have various possible variations as to how many software modules are included to automate the process.

As described in a study guide from the Project Management Institute (130 South State Road, Upper Darby, Pa., 10982), resource planning can be defined as “the process of determining the physical resources and quantities of each that would be required to perform project activities. Inputs into resource planning might include a work breakdown structure (WBS), historical information, scope statement, resource pool description, and organizational policies.” The WBS is a hierarchical decomposition of the project's tasks into simpler tasks that are used to plan and manage the project. These tasks can then be used to generate Gannt and PERT (Program Evaluation Review Technique) charts in project planning software such as Microsoft Project®.

“Methods used during resource planning can include:
Expert judgment: consultants, professionals and technical associations, industry groups, other units within the performing organization; and
Alternatives identification: any technique such as brainstorming and lateral thinking, as used to generate different approaches to the project.

The outputs of resources planning include resource requirements (e.g., a description of the types of resources required and their quantities).”

As further described in the above-identified study guide, “on some projects, and especially smaller projects, resource planning, cost estimating, and cost budgeting are closely linked and, therefore, viewed as a single process. For example, they may be performed by a single individual over a relatively short period of time. However, they are distinct processes because the tools and techniques for each are different.”

All of the possible variations described above are intended as included in the present invention. That is, the present invention should be viewed as describing a method (and structure), using sampling of the code listing(s) or software programs, to estimate cost and/or resources and, possibly, risk parameters, for software efforts such as platform porting and maintenance.

In addition to the versions described above, one of ordinary skill in the art would readily recognize that the present invention could include variations in which a computer network, such as the Internet or a local or area network, is used so that steps of the process described in business process 301 or 303, and in apparatus 302 and 304, are actually carried out on different computers in the network.

One of ordinary skill in the art would also readily recognize that the business process 301 or 303 could also be carried out by various business entities. That is, it is possible to execute the present invention in various steps by various entities. For example, a first entity such as a software company might approach a second entity such as a business consultant to execute one or more steps described in the present invention in order to obtain information for cost or resource estimation for purposes of planning a software effort such as porting or maintenance.

The present invention is intended to include this aspect in which one entity performs only specific steps of the method described herein and another entity performs other steps of the method by using information from the first entity.

Thus, one of ordinary skill in the art would readily recognize that the present invention could be implemented as a business process in which an entity provides a consultation service (e.g., or other such service) in which cost, risk, resource planning, or risk management planning is calculated at the request of an end user, and that such consultation service might even be available via the Internet. All such implementations are intended as being protected by the present application.

Exemplary Hardware Implementation

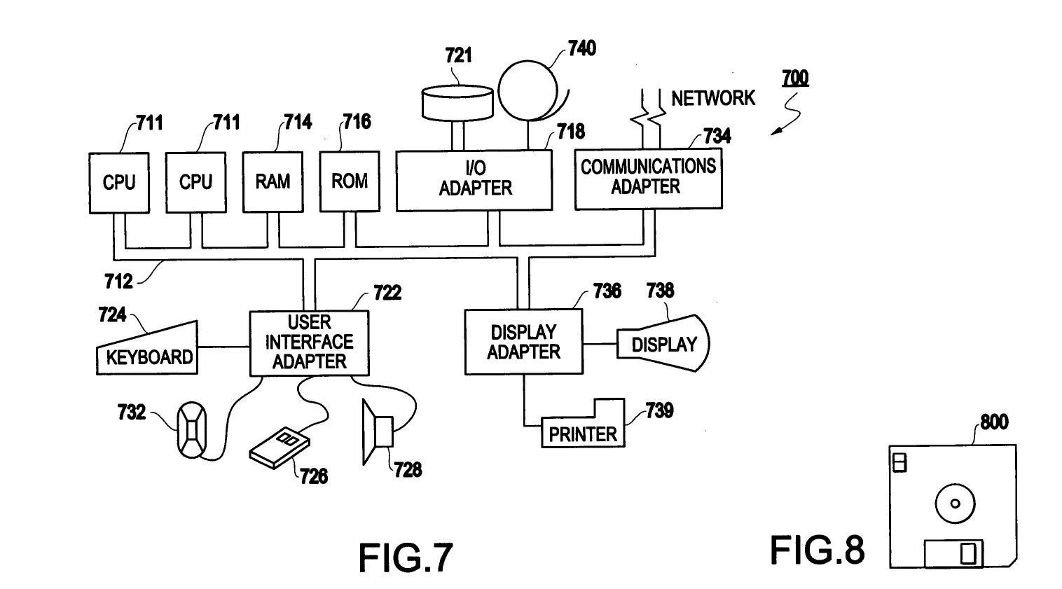

FIG. 7 illustrates a typical hardware configuration of an information handling/computer system in accordance with the invention and which preferably has at least one processor or central processing unit (CPU) 711.

The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, an Intranet, a personal area network (PAN), etc., and a display adapter 736 for connecting the bus 712 to a display device 738 and/or printer 739 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 711 and hardware above, to perform the method of the invention.

This signal-bearing media may include, for example, a RAM contained within the CPU 711, as represented by the fast-access storage for example. Alternatively, the instructions may be contained in another signal-bearing media, such as a magnetic data storage diskette 800 (FIG. 8), directly or indirectly accessible by the CPU 711.

Whether contained in the diskette 800, the computer/CPU 711, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

1. A method of estimating a cost related to at least one of computer software development, computer software maintenance, and information technology services, said method comprising:
reading a sample of computer code in accordance with a sampling technique; and
calculating a cost for a larger subset of the computer code from said sampling,
wherein at least one of said reading, said sampling, and said calculating is executed on a computer.

2. The method of claim 1, wherein said cost is for at least one of:
porting said software to another platform;
maintenance of said software;
application portfolio management of said software; and
legacy transformation of said software.

3. The method of claim 1, further comprising at least one of:
calculating a variability of said cost due to sampling error; and
calculating a probability that said cost will be lower than the cost that would have been estimated by using a sample including 100% of the code.

4. The method of claim 1, further comprising:
categorizing each computer sampling into one of N categories of difficulty, N being an integer greater than 1.

5. The method of claim 1, further comprising:
reading into a computer at least one of a rule by which said sampling is to be executed, and cost parameters to be used for said calculating.

6. The method of claim 4, wherein said categorizing comprises at least one of:
a user-assisted technique in which a user enters a category for each said sampled computer code lines; and
an automated technique in which a software tool parses each said sampled computer code line and generates a category for each parsed computer code line.

7. The method of claim 1, wherein said sample is taken using at least one of:
simple random sampling;
cluster sampling; and
stratified sampling.

8. The method of claim 1, wherein the sample includes at least one of:
a line of code;
a file or module from an application or set of applications;
an initial part of a file or a module from an application or set of applications; and
an application from a set of applications.

9. A method of estimating necessary amounts of resources for an effort related to at least one of computer software development, computer software maintenance, and information technology services, said method comprising:
reading a sample of computer code in accordance with a sampling technique; and
calculating resources for a larger subset of the computer code from said sampling,
wherein at least one of said reading, said sampling, and said calculating is executed on a computer.

10. The method of claim 9, wherein said resources are for at least one of:
porting said software to another platform;
maintenance of said software;
application portfolio management of said software; and
legacy transformation of said software

11. The method of claim 9, further comprising at least one of:
calculating one or more variabilities of said amounts of resources due to sampling error; and
calculating a probability that said amount of resources will be less than the amounts of resources that would have been estimated by using a sample including 100% of the code.

12. The method of claim 9, further comprising:
categorizing each computer sampling into one of N categories of difficulty, N being an integer greater than 1.

13. The method of claim 9, further comprising:
reading into a computer at least one of a rule by which said sampling is to be executed, and resource parameters to be used for said calculating.

14. The method of claim 9, further comprising:
creating at least one of a resource plan and a work breakdown structure based on the calculated resources.

15. The method of claim 11, further comprising:
creating a risk management plan based on calculated risk parameters.

16. The method of claim 12, wherein said categorizing comprises at least one of:
a user-assisted technique in which a user enters a category for each said sampled computer code lines; and
an automated technique in which a software tool parses each said sampled computer code line and generates a category for each parsed computer code line.

17. The method of claim 9, wherein said sample is taken using at least one of:
simple random sampling;
cluster sampling; and
stratified sampling.

18. The method of claim 9, wherein the sample includes at least one of a line of code;
a file or a module from an application or set of applications;
an initial part of a file or a module from an application or set of applications; and
an application from a set of applications.

19. A business method comprising at least one of:
estimating a cost for an effort related to at least one of computer software development and information technology (IT) services, said estimating method comprising:
sampling computer code in accordance with a sampling technique;
calculating said cost for a larger subset of the computer code from said computer code from said sampling; and
calculating at least one of a risk probability and an estimation precision for said cost,
wherein at least one of said reading, said sampling, and said calculating is executed on a computer;
providing a result of said calculating to a party; and
receiving said result of said calculating.

20. The business method of claim 19, wherein said effort comprises at least one of:
porting said software to another platform;
maintenance of said software;
application portfolio management of said software; and
legacy transformation of said software.

21. A business method comprising at least one of:
estimating a necessary amount of resources for an effort related to at least one of computer software development and information technology (IT) services, said estimating method comprising:
sampling computer code in accordance with a sampling technique;
calculating said necessary amount of resources for a larger subset of the computer code from said computer code from said sampling; and
calculating at least one of a risk probability and an estimation precision for said estimate of amount of resources,
wherein at least one of said reading, said sampling, and said calculating is executed on a computer;
providing a result of said calculating to a party; and
receiving said result of said calculating.

22. The business method of claim 21, wherein said effort comprises at least one of:
porting said software to another platform;
maintenance of said software;
application portfolio management of said software; and
legacy transformation of said software

23. An apparatus to estimate at least one of a cost and an amount of necessary resources for an effort related to computer software development, computer software maintenance, and information technology services, said apparatus comprising:
a memory to store a computer code involved in an effort related to software development;
a graphic user interface to allow said computer code to be selected; and
a sampling module to allow said computer code to be sampled in accordance with a sampling technique.

24. The apparatus of claim 23, wherein said effort comprises one of:
porting said computer code to another platform;
maintaining said computer code;
performing application portfolio management on said computer code; and
performing legacy transformation on said code.

25. A signal-bearing medium tangibly embodying a program of machine-readable instructions executable by a digital processing apparatus to perform a method of estimating at least one of a cost and a necessary amount of resources for an effort related to computer software development, computer software maintenance, and information technology services, said method comprising:
reading a section of computer code;
sampling said computer code in accordance with a sampling technique; and
using said sampling to calculating said at least one of cost and amount of resources for a larger subset of the computer code from said computer code from said sampling,
wherein said sampling, and said calculating is executed on a computer.

26. The signal bearing medium of claim 25, wherein said effort comprises one of:
porting said computer code to another platform;
maintaining said computer code;
performing application portfolio management on said computer code; and
performing legacy transformation on said code.

27. An apparatus to estimate a cost for an effort related to computer software development, computer software maintenance, and information technology services, said apparatus comprising:
means for storing a computer code involved in an effort related to software development;
means for allowing said computer code to be selected; and
means for allowing said computer code to be sampled in accordance with a sampling technique.

28. The apparatus of claim 27, wherein said effort comprises one of:
porting said computer code to another platform;
maintaining said computer code;
performing application portfolio management on said computer code; and
performing legacy transformation on said code.

29. The apparatus according to claim 27, further comprising:
means for calculating said cost for a larger subset of the computer code from said computer code from said sampling.

30. The apparatus according to claim 29, further comprising:
means for calculating at least one of a risk probability and an estimation precision for said cost.

31. The apparatus of claim 27, further comprising:
means for categorizing each computer sampling into one of N categories of difficulty, N being an integer greater than 1.

32. An apparatus to estimate an amount of necessary resources for an effort related to computer software development, computer software maintenance, and information technology services, said apparatus comprising:
means for storing a computer code involved in an effort related to software development;
means for allowing said computer code to be selected; and
means for allowing said computer code to be sampled in accordance with a sampling technique.

33. The apparatus of claim 32, wherein said effort comprises one of:
porting said computer code to another platform;
maintaining said computer code;
performing application portfolio management on said computer code; and
performing legacy transformation on said code

34. The apparatus according to claim 32, further comprising:
means for calculating said amount of necessary resources for a larger subset of the computer code from said computer code from said sampling.

35. The apparatus according to claim 32, further comprising:
means for calculating at least one of a risk probability and an estimation precision for said amount of necessary resources.

36. The apparatus of claim 32, further comprising:
means for categorizing each computer sampling into one of N categories of difficulty, N being an integer greater than 1.

37. A method for deploying computing infrastructure, comprising integrating computer-readable code into a computing system, wherein the code in combination with the computing system is capable of performing the method of claim 1.

38. A method for deploying computing infrastructure, comprising integrating computer-readable code into a computing system, wherein the code in combination with the computing system is capable of performing the method of claim 9.
